(19) United States
(12) Patent Application Publication
(10) Pub. No.: US 2016/0238701 A1
(43) Pub. Date: Aug. 18, 2016

(54) GAZE RECOGNITION SYSTEM AND METHOD

(71) Applicant: HYUNDAI MOTOR COMPANY, Seoul (KR)

(72) Inventors: Kwang Myung OH, Daejeon (KR); Sung Jin SAH, Suwon-si (KR); Sung Min PARK, Seoul (KR); Hui Sung LEE, Gunpo-si (KR)

(21) Appl. No.: 14/838,346

(22) Filed: Aug. 27, 2015

(30) Foreign Application Priority Data
Feb. 12, 2015 (KR) 10-2015-0021492

(51) Int. Cl. G01S 11/14; G10K 11/18; G01S 15/93

(52) U.S. Cl. CPC G01S 11/14; G01S 15/93; G10K 11/18

(57) ABSTRACT

A gaze recognition method includes: a signal sensing step of sensing sound wave signals output from one or more sound wave transmitters disposed on a head of a user; a signal analyzing step of analyzing the sensed sound wave signals; and a gaze recognizing step of sensing relative displacement of the sound wave transmitters through signal analysis results for the sound wave signals to recognize a gaze change of the user.

### CROSS-REFERENCE TO RELATED APPLICATION

This application is based on and claims the benefit of priority to Korean Patent Application No. 10-2015-0021492, filed on Feb. 12, 2015 in the Korean Intellectual Property Office, the disclosure of which is incorporated herein in its entirety by reference.

### TECHNICAL FIELD

The present disclosure relates to a gaze recognition system and method, and more particularly, to a gaze recognition system and method capable of recognizing a gaze of a user by attaching an apparatus generating a sound wave to an accessory worn on a head of the user and analyzing a sound wave output from the apparatus.

### BACKGROUND

Generally, a gaze recognition system tracks movement of a face and/or a pupil of a user by processing an image obtained through a camera. The camera based gaze recognition system as described above recognizes a gaze of a driver by installing the camera in a vehicle or recognizes a gaze of a user wearing glasses such as Google Glass to the camera by attaching the camera to the glasses.

Alternatively, an infrared type gaze recognition system tracks a gaze by transmitting an infrared ray to a user and recognizing movement of a face or a pupil of the user through the received infrared ray (light).

As described above, the camera based gaze recognition system and the infrared type gaze recognition system, which are expensive, have a difficulty in mass production, and have a recognition rate decreased when shade is partially created on the face by external light and an amount of light is changed.

In addition, the camera based gaze recognition system consumes a large amount of times and resources in distinguishing a face of a person and a background in an image obtained through the camera from each other. In other words, in the related art, a complicated algorithm and resources depending on the complicated algorithm are required in order to distinguish a three-dimensional form of the face and separate the three-dimensional form of the face from the background. The gaze recognition system as described above has high utilization in recognizing a driver gaze in an actual vehicle environment, but requires an expensive device in order to obtain a vector having high resolution.

In addition, in a glasses type gaze recognition apparatus according to the related art, since the user should wear glasses to which the camera is attached, a burden due to the wearing of the glasses is provided to the user.

### SUMMARY

The present disclosure has been made to solve the above-mentioned problems occurring in the prior art while advantages achieved by the prior art are maintained intact.

An aspect of the present disclosure provides a gaze recognition system and method capable of recognizing a gaze of a user by attaching an apparatus generating a sound wave to an accessory worn on a head of the user and analyzing a sound wave output from the apparatus.

According to an exemplary embodiment of the present disclosure, a gaze recognition method includes: a signal sensing step of sensing sound wave signals output from one or more sound wave transmitters disposed on a head of a user; a signal analyzing step of analyzing the sensed sound wave signals; and a gaze recognizing step of sensing relative displacement of the sound wave transmitters through signal analysis results for the sound wave signals to recognize a gaze change of the user.

The sound wave transmitters may generate sound wave signals having different patterns.

The sound wave signals may be implemented by an ultrasonic wave or a high frequency wave that is out of an audio frequency range of a human.

In the signal analyzing step, an intensity change of the sound wave signals depending on relative distance changes of the sound wave transmitters may be calculated.

In the signal analyzing step, a frequency deviation of the sound wave signals due to the Doppler effect depending on movement of the sound wave transmitters may be calculated.

In the gaze recognizing step, a three-dimensional vector toward which an accessory to which the sound wave transmitters are attached is directed may be derived.

The gaze recognition method may further include a warning outputting step of outputting a warning signal depending on the gaze change of the user.

According to another exemplary embodiment of the present disclosure, a gaze recognition system includes: one or more sound wave transmitters configured to be attachable to or detachable from an accessory worn on a head of a user and output different sound wave signals; and a gaze recognizer configured to receive the sound wave signals output from the one or more sound wave transmitters and sense relative displacement of the sound wave transmitters through an analysis of the received sound wave signals to recognize a gaze change of the user.

The sound wave transmitter may include: a sound wave generator configured to generate sound wave signals having predefined patterns; and a sound wave output configured to output the sound wave signals to the outside.

The sound wave transmitter may further include a wearing sensor configured to sense whether or not the user wears the accessory.

The gaze recognizer may include: a sound wave sensor configured to sense the sound wave signals; a calculator configured to calculate relative positions of the sound wave transmitters; and a controller configured to recognize a gaze of the user based on the relative positions of the sound wave transmitters.

The calculator may calculate an intensity change of sound wave signals output from corresponding sound wave transmitters depending on relative distance changes of the sound wave transmitters from the sound wave sensor.

The calculator may calculate a frequency deviation of sound wave signals output from corresponding sound wave transmitters due to the Doppler effect depending on movement of the sound wave transmitters.

The gaze recognizer may further include an input configured to generate an input signal depending on gaze movement of the user recognized by the controller.

The gaze recognizer may further include a warning unit configured to detect whether or not driving of the user is safe depending on gaze information of the user to output a warning.

The gaze recognizer may further include a vehicle controller configured to detect whether or not the user recognizes an obstacle based on a gaze recognition result of the user and control driving of a vehicle so as to avoid the obstacle when it is detected that the user does not recognize the obstacle.

According to another exemplary embodiment of the present disclosure, a gaze recognition method includes steps of: outputting, by sound wave transmitters associated with a head of a driver of a vehicle, sound wave signals having different patterns; sensing, by sound wave sensors disposed at different locations of the vehicle, the sound wave signals output from the sound wave transmitters; determining, by a calculator, a gaze change of the driver by calculating movement of the sound wave transmitters with reference to the sound wave sensors based on the sensed sound wave signals; and performing, by a vehicle controller, a predetermined operation of the vehicle in accordance with the determined gaze change of the driver.

The predetermined operation of the vehicle may be one selected from the group consisting of outputting a warning signal to the driver, and activating or deactivating an apparatus of the vehicle located on a path of a gaze of the driver based on the determined gaze change of the driver.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram of a gaze recognition system according to an exemplary embodiment of the present disclosure.

FIG. 2 is an illustrative view illustrating an example in which a sound wave transmitter and a sound wave sensor illustrated in FIG. 1 are installed.

FIG. 3 is a flow chart showing a sound wave signal transmitting process of the sound wave transmitter according to the exemplary embodiment of the present disclosure.

FIG. 4 is a flow chart showing a gaze recognition method according to the exemplary embodiment of the present disclosure.

### DETAILED DESCRIPTION

Hereinafter, exemplary embodiments of the present disclosure will be described in detail with reference to the accompanying drawings.

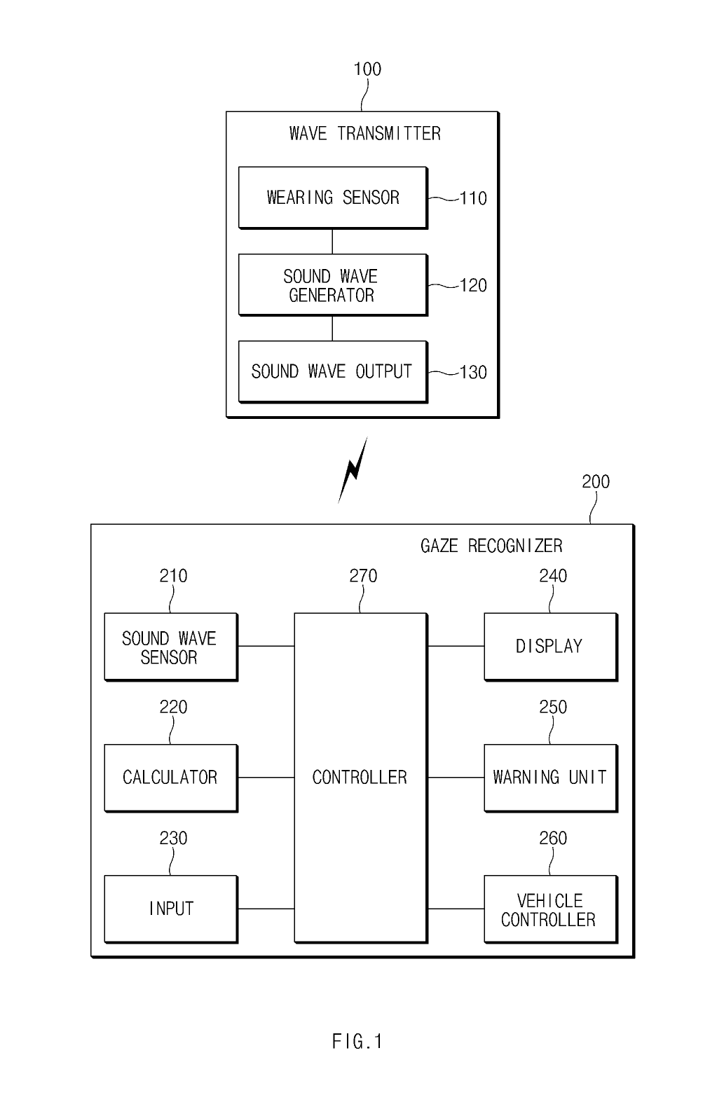

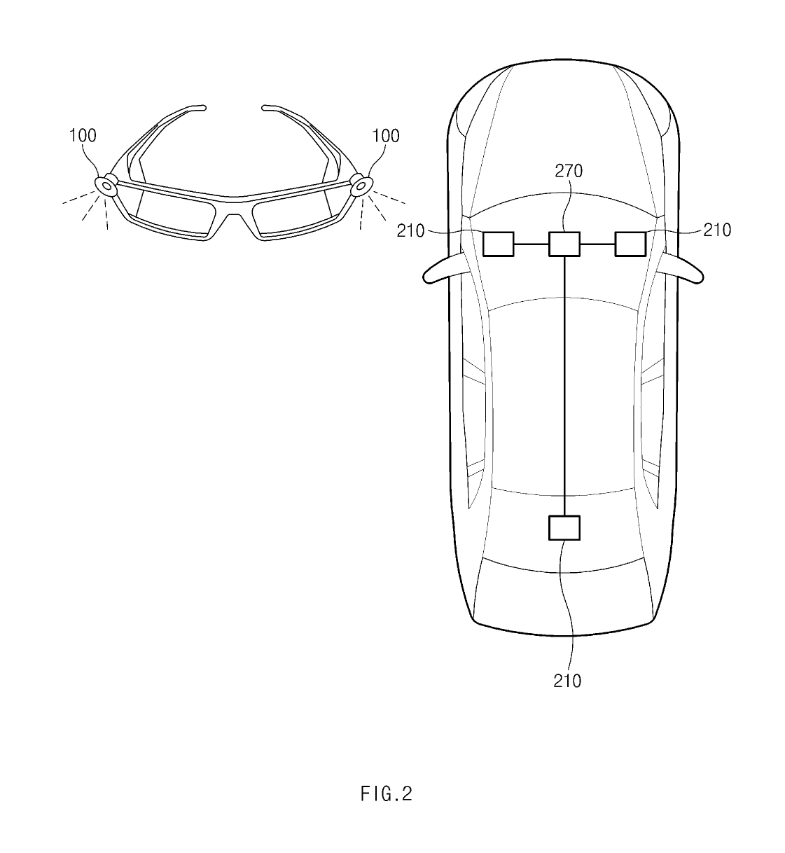

FIG. 1 is a block diagram of a gaze recognition system according to an exemplary embodiment of the present disclosure, and FIG. 2 is an illustrative view illustrating an example in which a sound wave transmitter and a sound wave sensor illustrated in FIG. 1 are installed.

As illustrated in FIG. 1, the gaze recognition system is configured to include sound wave transmitters 100 and a gaze recognizer 200.

The sound wave transmitters 100 are implemented in a form in which they are attachable to or detachable from an accessory (for example, glasses, sunglasses, a cap, or the like) worn on a head of a user or a form in which they are coupled to the accessory. When the accessory to which the sound wave transmitters 100 are attached is worn on the head of the user, the sound wave transmitters 100 generate predefined sound wave signals having different pulses at the same time interval per unit time. That is, the sound wave transmitters 100 output sound wave signals having different patterns.

For example, in the case in which the sound wave transmitters 100 are attached to the glasses, they are installed at the left and the right of the glasses, respectively, as illustrated in FIG. 2, and these two sound wave transmitters 100 generate the sound wave signals having the different patterns.

Each sound wave transmitter 100 includes a wearing sensor 110, a sound wave generator 120, and a sound wave output 130.

The wearing sensor 110 senses whether or not the user wears the sound wave transmitter 100 to output an operation signal (sound wave signal generation) or a stop signal (sound wave signal generation stop). The wearing sensor 110 may be implemented by a proximity sensor, a heat sensor, or the like. Although the case in which the wearing sensor 110 is implemented by the sensor has been disclosed in the present exemplary embodiment, the present disclosure is not limited thereto. That is, the wearing sensor 110 may also be implemented by hardware such as a switch.

The sound wave generator 120 generates sound wave signals having defined patterns when it receives a control signal instructing an operation from the wearing sensor 110. The sound wave generator 120 generates a sound wave (for example, an ultrasonic wave, a high frequency wave, or the like) that is out of an audio frequency range of a person.

The sound wave output 130 outputs the sound wave signals generated by the sound wave generator 120 to the outside. The sound wave output 130 is implemented by a small speaker.

The gaze recognizer 200 senses the sound wave signals output from the sound wave transmitter 100 and recognizes a position of the sound wave transmitter 100 using the sound wave signals to sense a gaze change of the user. The gaze recognizer 200 is installed in a vehicle.

The gaze recognizer 200 includes sound wave sensors 210, a calculator 220, an input 230, a display 240, a warning unit 250, a vehicle controller 260, and a controller 270.

The sound wave sensors 210 are installed at one or more fixed positions predefined in the vehicle. For example, as illustrated in FIG. 2, two sound wave sensors 210 are installed at the front in the vehicle and one sound wave sensor 210 is installed at the rear in the vehicle.

The sound wave sensors 210 recognize the sound wave signals generated by one or more sound wave transmitters 100. The sound wave sensors 210 may be implemented using a microphone pre-installed in the vehicle.

The sound wave sensors 210 receive the sound wave signals output from one or more sound wave transmitters 100 and recognize patterns of the sound wave signals. In other words, the sound wave sensors 210 divide and classify the received one or more sound wave signals for each sound wave transmitter 100.

The calculator 220 calculates intensity of the sound wave signals sensed through the sound wave sensors 210 and a frequency deviation due to the Doppler effect and sense relative displacement of the sound wave transmitters 100. In the present exemplary embodiment, since the sound wave sensors 210 installed at one or more specific positions using characteristics of a space in the vehicle, which is a limited space, have physically fixed position coordinates, positions and movement changes of the sound wave transmitters 100 outputting the sound wave signals may be calculated.

In other words, the calculator 220 calculates an intensity change of the sound wave changed depending on relative distance changes of the sound wave transmitters 100 based on the sound wave sensor 210. In addition, the calculator 220 may calculate the frequency deviation due to the Doppler effect depending on the movement of the sound wave transmitters 100.

The calculator 220 may calculate how spatial coordinates of the sound wave transmitters 100 are changed through a time difference between first received sound wave signals (pulse signals) in order to avoid reflection reception. In other words, when the calculator 220 receives different sound wave signals simultaneously generated by the respective sound wave transmitters 100, it calculates a time difference between the received sound wave signals. This is to use the fact that times required for the sound wave signals output from the respective sound wave transmitters 100 to arrive at the sound wave sensor 210 are different from each other since the sound wave transmitters 100 move depending on gaze movement (head movement) of the user.

The calculator 220 may analyze the sound wave signals received from the one or more sound wave sensors 210 to derive a three-dimensional vector toward which the accessory (for example, the glasses) to which the sound wave transmitters 100 are attached is directed.

The input 230, which is for the user to input data and control commands, may be implemented by any one or more of input apparatuses such as a button, a switch, a touch pad, a touch screen, and the like.

Alternatively, the input 230 detects the head movement (gaze movement) of the user and generates a simply selection input such as Yes or No depending on the head movement of the user.

The display 240 displays various data such as a progress situation, a result, and the like, depending on an operation of the gaze recognizer 200.

The display 240 may include one or more of a liquid crystal display (LCD), a thin film transistor-liquid crystal display (TFT LCD), an organic light-emitting diode (OLED), a flexible display, a 3D display, a transparent display, a head-up display, and a touch screen.

The warning unit 250 outputs a warning signal based on gaze information of the user. For example, the warning unit 250 outputs a warning signal when a gaze of the user goes down or movement of the user is a reference or less. Alternatively, the warning unit 250 outputs a warning signal when appropriate gaze movement of a driver is not present, in association with lane departure, proximity vehicle information, and the like.

The vehicle controller 260 controls an operation of the vehicle depending on gaze recognition. For example, the vehicle controller 260 detects whether or not the user recognizes an obstacle based on a result obtained by tracking a gaze direction of the user and controls the driving of the vehicle so as to avoid the obstacle when it is detected that the user does not recognize the obstacle.

The warning unit 250 and the vehicle controller 260 are connected to the controller 270 through a vehicle network. The vehicle network may be implemented by any one of a controller area network (CAN), a media oriented systems transport (MOST) network, and a local interconnect network (LIN).

The controller 270 recognizes the gaze direction of the user based on the positions and the movement changes of the sound wave transmitters 100 calculated by the calculator 220. In other words, the controller 270 recognizes toward which direction the gaze of the user is directed based on a calculation result of the calculator 220.

The controller 270 analyzes the head movement of the user using the sound wave sensors 210 having the fixed position coordinates, thereby making it possible to improve usability, for example, enter a preparation mode or turn on an illumination device in advance using the gaze information at the time of performing an indoor audio video navigation (AVN) control or a display control.

In addition, the controller 270 may allow information outside the vehicle to be displayed on left and right electronic displays using an operation of confirming surrounding vehicles through side mirrors at the time of changing a lane as it is.

As described above, in the present exemplary embodiment, since information is displayed only when the driver (user) shows a certain intention, for example, when the driver (user) horizontally moves his/her head, the display does not need to be always turned on. Therefore, gaze dispersion generated since the left and right electronic displays are always turned on may be decreased, and concentration of the information may be increased since the display is turned on if necessary.

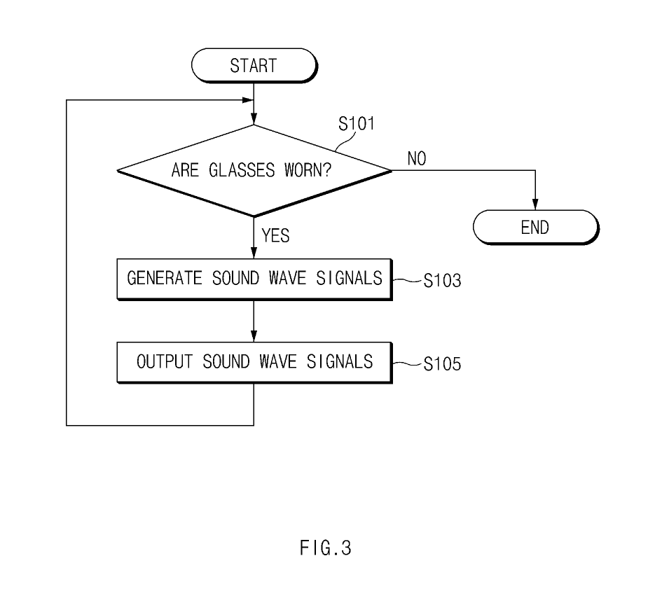

FIG. 3 is a flow chart showing a sound wave signal transmitting process of the sound wave transmitter according to the exemplary embodiment of the present disclosure. In the present exemplary embodiment, the case in which the sound wave transmitters are attached to the glasses will be described by way of example.

The sound wave transmitter 100 confirms whether the user wears the glasses (S101). That is, the wearing sensor 110 of the sound wave transmitter 100 confirms whether the user wears the glasses to which the sound wave transmitter 100 is attached.

The sound wave transmitter 100 controls the sound wave generator 120 to generate sound wave signals having predefined specific patterns (S103), when it is sensed that the user wears the glasses. In this case, the sound wave generator 120 generates sound wave signals having different pulses.

The sound wave output 130 of the sound wave transmitter 100 outputs the sound wave signals generated by the sound wave generator 120 to the outside (S105).

Then, the sound wave transmitter 100 recognizes that the user does not wear the glasses to stop an operation, when the user takes off the glasses to which the sound wave transmitter is attached. That is, the sound wave transmitter stops transmission of the sound wave signals.

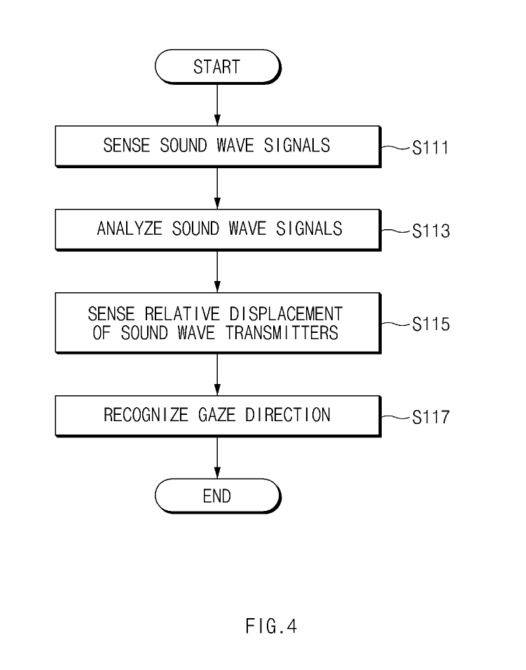

FIG. 4 is a flow chart showing a gaze recognition method according to the exemplary embodiment of the present disclosure.

The gaze recognizer 200 senses the sound wave signals output from the one or more sound wave transmitters 100 through the one or more sound wave sensors 210 (S111). Here, the sound wave sensors 210 are installed at one or more fixed positions in the vehicle and receives the sound wave signals output from the one or more sound wave transmitters 100 and having different patterns.

The gaze recognizer 200 analyzes the sensed sound wave signals (S113). The calculator 220 of the gaze recognizer 200 calculates the intensity change of the sound wave signals depending on a distance change of the sound wave transmitters 100 from the sound wave sensor 210 and calculates the frequency deviation due to the Doppler effect depending on the movement of the sound wave transmitters 100.

The gaze recognizer 200 analyzes the sound wave signals to sense relative displacement of the sound wave transmitters 100 (S115). The calculator 220 recognizes the relative displacement of the sound wave transmitters 100 based on calculation results such as the intensity change of the sound wave signals and the frequency deviation.

The gaze recognizer 200 recognizes the gaze direction based on the relative displacement of the sound wave transmitters 100 (S117).

As described above, according to the exemplary embodiments of the present disclosure, the sound wave transmitters attachable to or detachable from the accessory worn on the head of the user are disposed, the sound waves output from the sound wave transmitters are sensed and recognized, and the gaze recognizer calculating relative positions and movement of the sound wave transmitters is disposed in the vehicle, thereby making it possible to decrease a burden due to the wearing of the user.

In addition, according to the exemplary embodiments of the present disclosure, the gaze recognizer is attached to and used at the fixed position in the vehicle, thereby making it possible to improve a recognition rate in recognizing the gaze.

Further, according to the exemplary embodiments of the present disclosure, since the gaze recognizer tracks and calculates a relative change amount of the sound waves depending on the movement of the head of the user, it is robust to an influence of a vehicle environment such as a change in external light.

Furthermore, according to the exemplary embodiments of the present disclosure, the gaze of the driver may be recognized at a comparatively low cost.

What is claimed is:

1. A gaze recognition method comprising:
a signal sensing step of sensing sound wave signals output from one or more sound wave transmitters disposed on a head of a user;
a signal analyzing step of analyzing the sensed sound wave signals; and
a gaze recognizing step of sensing relative displacement of the sound wave transmitters through signal analysis results for the sound wave signals to recognize a gaze change of the user.

2. The gaze recognition method according to claim 1, wherein the sound wave transmitters generate sound wave signals having different patterns.

3. The gaze recognition method according to claim 1, wherein the sound wave signals are implemented by an ultrasonic wave or a high frequency wave that is out of an audio frequency range of a human.

4. The gaze recognition method according to claim 1, wherein in the signal analyzing step, an intensity change of the sound wave signals depending on relative distance changes of the sound wave transmitters is calculated.

5. The gaze recognition method according to claim 1, wherein in the signal analyzing step, a frequency deviation of the sound wave signals due to the Doppler effect depending on movement of the sound wave transmitters is calculated.

6. The gaze recognition method according to claim 1, wherein in the signal analyzing step, a time difference between different sound wave signals simultaneously generated by the respective sound wave transmitters depending on movement of the sound wave transmitters is calculated.

7. The gaze recognition method according to claim 1, wherein in the gaze recognizing step, a three-dimensional vector toward which an accessory to which the sound wave transmitters are attached is directed is derived.

8. The gaze recognition method according to claim 1, further comprising a warning outputting step of outputting a warning signal depending on the gaze change of the user.

9. A gaze recognition system comprising:
one or more sound wave transmitters configured to be attachable to or detachable from an accessory worn on a head of a user and output different sound wave signals; and
a gaze recognizer configured to receive the sound wave signals output from the one or more sound wave transmitters and sense relative displacement of the sound wave transmitters through an analysis of the received sound wave signals to recognize a gaze change of the user.

10. The gaze recognition system according to claim 9, wherein each sound wave transmitter includes:
a sound wave generator configured to generate sound wave signals having predefined patterns; and
a sound wave output configured to output the sound wave signals to the outside.

11. The gaze recognition system according to claim 10, wherein the one or more sound wave transmitters further includes a wearing sensor configured to sense whether or not the user wears the accessory.

12. The gaze recognition system according to claim 9, wherein the gaze recognizer includes:
a sound wave sensor configured to sense the sound wave signals output from the one or more sound wave transmitters;
a calculator configured to calculate relative positions of the sound wave transmitters; and
a controller configured to recognize a gaze of the user based on the relative positions of the sound wave transmitters.

13. The gaze recognition system according to claim 12, wherein the calculator calculates an intensity change of sound wave signals output from corresponding sound wave transmitters depending on relative distance changes of the sound wave transmitters from the sound wave sensor.

14. The gaze recognition system according to claim 12, wherein the calculator calculates a frequency deviation of sound wave signals output from corresponding sound wave transmitters due to the Doppler effect depending on movement of the sound wave transmitters.

15. The gaze recognition system according to claim 12, wherein the calculator calculates a time difference between different sound wave signals simultaneously generated by the respective sound wave transmitters depending on movement of the sound wave transmitters.

16. The gaze recognition system according to claim 12, wherein the gaze recognizer further includes an input configured to generate an input signal depending on gaze movement of the user recognized by the controller.

17. The gaze recognition system according to claim 12, wherein the gaze recognizer further includes a warning unit configured to detect whether or not driving of the user is safe depending on gaze information of the user to output a warning.

18. The gaze recognition system according to claim 12, wherein the gaze recognizer further includes a vehicle controller configured to detect whether or not the user recognizes an obstacle based on a gaze recognition result of the user and control driving of a vehicle so as to avoid the obstacle when it is detected that the user does not recognize the obstacle.

19. A gaze recognition method, comprising steps of:
outputting, by sound wave transmitters associated with a head of a driver of a vehicle, sound wave signals having different patterns;
sensing, by sound wave sensors disposed at different locations of the vehicle, the sound wave signals output from the sound wave transmitters;
determining, by a calculator, a gaze change of the driver by calculating movement of the sound wave transmitters with reference to the sound wave sensors based on the sensed sound wave signals; and
performing, by a vehicle controller, a predetermined operation of the vehicle in accordance with the determined gaze change of the driver.

20. The gaze recognition method according to claim 19, wherein the predetermined operation of the vehicle is one selected from the group consisting of outputting a warning signal to the driver, and activating or deactivating an apparatus of the vehicle located on a path of a gaze of the driver based on the determined gaze change of the driver.
